(19) United States
(12) Patent Application Publication
(10) Pub. No.: US 2019/0115183 A1
(43) Pub. Date: Apr. 18, 2019

(54) STATIONARY ANODE X-RAY TUBE

(71) Applicant: TOSHIBA ELECTRON TUBES & DEVICES CO., LTD., Otawara-shi (JP)

(72) Inventor: Tomonobu SAITO, Yaita (JP)

(73) Assignee: TOSHIBA ELECTRON TUBES & DEVICES CO., LTD, Otawara-shi (JP)

(21) Appl. No.: 16/158,336

(22) Filed: Oct. 12, 2018

(30) Foreign Application Priority Data
Oct. 13, 2017 (JP) 2017-199345

(51) Int. Cl. H01J 35/08; H01J 35/06; H01J 35/16

(52) U.S. Cl. CPC H01J 35/08; H01J 35/06; H01J 2235/18; H01J 2235/086; H01J 35/16

(57) ABSTRACT

According to one embodiment, a stationary anode X-ray tube includes a cathode, an anode, an anode hood, an X-ray transmissive window and a vacuum envelope. A target surface of the anode is an inclined surface disposed to be spaced further away from the cathode towards a first direction. An angle made with respect to a second direction as the first direction is pivoted clockwise or counter-clockwise is any degree but 0°.

### CROSS-REFERENCE TO RELATED APPLICATIONS

This application is based upon and claims the benefit of priority from Japanese Patent Application No. 2017-199345, filed Oct. 13, 2017, the entire contents of which are incorporated herein by reference.

### FIELD

Embodiments described herein relate generally to a stationary anode X-ray tube.

### BACKGROUND

X-ray tubes are used, for example, in diagnostic imaging devices for medical or dental for X-ray diagnosis, and also in industrial X-ray CT devices and X-ray analyzers. The X-ray tubes consist of a cathode which emits electrons in a vacuum envelope maintained at a vacuum airtight atmosphere, and an anode against which emitted electrons collide. When X-ray tube voltage is applied between the anode and the cathode, thermoelectrons are generated in the filament of the cathode and enter a target surface of the anode with accelerated speed, thus radiating an X-ray from a focal spot formed on the target surface.

The intensity of an X-ray radiated from a target surface is proportional to the square of the X-ray tube voltage, the X-ray tube current, which is the flow of thermoelectrons, and the atomic number of the element of the target material. As to the generation of an X-ray, an electric power obtained by the product of the X-ray tube voltage and the X-ray tube current is input to the anode, but only about 1% or less of the consumed power is converted into an X-ray, and the remaining 99% or more is converted into thermal energy. When an X-ray is radiated as electrons collide with the anode, recoil electrons are recoiled from the target surface. A conventional drawback in this technology is that the recoiled recoil electrons collide with the anode again to heat the anode, or collide with the vacuum envelope to cause a damage. To remove such a drawback, there is a technique in which an anode hood is installed around the anode to shield it from and trap recoil electrons. The anode hood comprises an X-ray transmissive window made from beryllium or the like, attached thereto.

When employed for X-ray imaging diagnosis or the like, the image quality (contrast) of the X-ray image needs to be improved for more accurate diagnosis, and therefore it is required to further increase the X-ray dosage radiated from the X-ray tube. To increase the X-ray dosage, the X-ray tube voltage and the X-ray tube current to be applied to the X-ray tube need to be increase. However, as the X-ray tube voltage and the X-ray tube current are increase further, the energy of the recoil electrons recoiled from the target surface also increases. Here, another drawback arises, in which when the recoil electrons collide with the X-ray transmissive window, the temperature of the material rises to cause melting and/or damage, etc., in the X-ray transmissive window. If the X-ray transmissive window melts in the vacuum envelope, gas emission and vapor deposition onto the vacuum envelope may occur. As a result, the withstand voltage characteristic may fall, possibly causing failure of the X-ray tube. Under these circumferences, the energy input to the X-ray tube is restricted.

### BRIEF DESCRIPTION OF THE DRAWINGS

FIG. 1 is a cross section showing a stationary anode X-ray tube according to an embodiment.

FIG. 2 is a partially expanded cross section showing the stationary anode X-ray tube of FIG. 1.

FIG. 3 is a cross section showing an anode hood and an X-ray transmissive window taken along line in FIG. 2, and also showing an anode in plan view.

FIG. 4 is a cross section showing a target layer shown in FIGS. 1 and 2, and illustrating the relationship between incident electrons entering the target layer and recoil electrons recoiling on the target layer.

FIG. 5 is a diagram of a graph showing a change in recoil electron energy with respect to an angle shown in FIG. 4.

FIG. 6 is a diagram of a graph showing a change in X-ray intensity to the angle shown in FIG. 4.

### DETAILED DESCRIPTION

In general, according to one embodiment, therein provided a stationary anode X-ray tube comprising a cathode which emits electrons, an anode disposed to oppose the cathode in a direction along a tube axis and comprising a target surface on which a focal spot which emits an X-ray is formed as emitted with an electron emitted from the cathode, an anode hood fixed to the anode, extending to a side of the cathode, surrounding the target surface, set at a same potential as that of the anode and comprising a first opening allowing electrons directed to the target surface from the cathode to pass therethrough and a second opening allowing an X-ray emitted from the focal spot to pass therethrough, an X-ray transmissive window which blocks the second opening of the anode hood and transmits an X-ray and an electrical insulating vacuum envelope which accommodates the cathode, the anode, the anode hood and the X-ray transmissive window. The target surface is an inclined surface disposed to be spaced further away from the cathode towards a first direction normal to the tube axis. When, with respect to a second direction directed from the focal spot to a center of the X-ray transmissive window, the anode and the X-ray transmissive window are viewed from the side of the cathode along the tube axis, an angle made with respect to the second direction when the first direction is pivoted clockwise or counter-clockwise is defined an angle θ, the angle θ is any angle but 0°.

An embodiment will be described with reference to the accompanying drawings. The disclosure is a mere example, and arbitrary change of gist which can be easily conceived by a person of ordinary skill in the art naturally falls within the inventive scope as long as the subject matter of the embodiments is maintained. To better clarify the explanations, the drawings may pictorially show width, thickness, shape, etc., of each portion as compared with an actual aspect, but they are mere examples and do not restrict the interpretation of the invention. In the present specification and drawings, after structural elements are each explained once with reference to the drawings, there is a case where their explanations will be omitted as appropriate, and those identical to or similar to the explained structural elements will be denoted by the same reference numbers, respectively, as the explained structural elements.

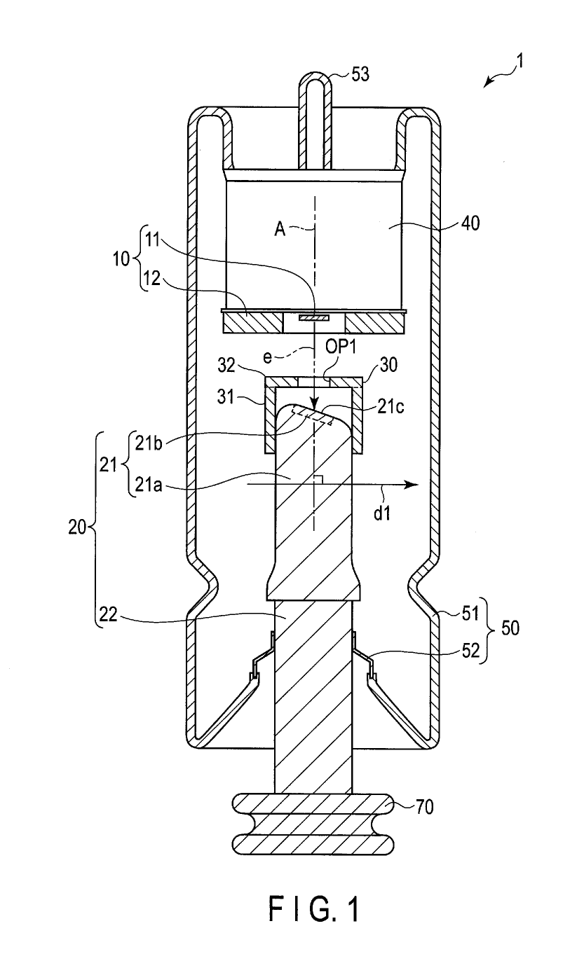

As shown in FIG. 1, a stationary anode X-ray tube 1 comprises a cathode 10, an anode 20, an anode hood 30, a cathode structure 40, a vacuum envelope 50 and a radiator 70.

The cathode 10 includes a filament 11 as an electron emission source which emits electrons, and a focusing electrode 12. In this embodiment, negative high voltage and a filament current are applied to the filament 11. Negative high voltage is applied to the focusing electrode 12. The cathode 10 is fixed to the cathode structure 40.

The anode 20 comprises an anode target 21 and an anode extending portion 22 connected to the anode target 21.

The anode target 21 is disposed to oppose the filament 11 (cathode 10) to as to be apart therefrom in a direction along a tube axis A. In this embodiment, the anode 20 is grounded. The anode target 21 includes a target body 21a and a target layer 21b. The target body 21a is formed into a cylindrical shape. The target body 21a is formed of a high heat conductive metal such as copper or a copper alloy.

The target layer 21b is provided in a portion of an end surface of the target body 21a. The target layer 21b is formed of a high melting-point metal such as tungsten (W) or a tungsten alloy. A target surface 21c of the target layer 21b, which is located on a side opposing the cathode 10 is inclined with respect to a virtual plane perpendicular to the tube axis A. The target surface 21c is an inclined surface disposed to be spaced further from the cathode 10 towards a first direction d1, which is normal to the tube axis A. On the target surface 21c, electrons emitted from the filament 11 and converged by the focusing electrode 12 are collided to form a focal spot (focal spot F, which will be described later) which emits an X-ray.

As in the case of the target body 21a, the anode extending portion 22 is formed to be cylindrical from a high heat conductive metal such as copper or a copper alloy. The anode extending portion 22 serves to fix the anode target 21 and transmit heat generated from the anode target 21 to the surroundings. In this embodiment, the radiator 70 is connected to the anode extending portion 22. The radiator 70 is formed of an electrical insulating or conductive material. For example, the radiator can be formed using ceramics, which has excellent properties in heat conduction and withstand voltage. With use of the radiator 70, the heat transfer from the X-ray tube 1 to the outside thereof can be promoted. Note that the radiator 70 should be provided in the X-ray tube 1 only if needed.

The anode hood 30 is fixed to the anode 20. In this embodiment, the anode hood 30 is fixed to the target body 21a by brazing. The anode hood 30 extends to a cathode 10 side so as to surround the target surface 21c. In this embodiment, the anode hood 30 includes a cylindrical portion 31 extending along the tube axis A and a lid portion 32 located between the cathode 10 and the anode 20 and blocking an end of the cylindrical portion 31.

The anode hood 30 is formed of a conductive material such as a metal. The anode hood 30 is set to the same potential as that of the anode 20. The lid portion 32 (anode hood 30) comprises a first opening OP1 which allows electrons to pass therethrough from the cathode 10 to the target surface 21c.

The vacuum envelope 50 accommodates the cathode 10, the anode target 21, the anode hood 30 and the like. The vacuum envelope 50 is formed so as to expose the anode extending portion 22. The vacuum envelope 50 is formed into a cylindrical shape with one end portion airtightly blocked by the cathode structure 40 and another end portion airtightly blocked by the anode 20. The inside of the vacuum envelope 50 is maintained at a predetermined degree of vacuum. Note that the inside of the vacuum envelope 50 is evacuated by using an exhaust port 53. The exhaust port 53 is airtightly sealed.

The vacuum envelope 50 includes an electrical insulating container formed from an electrical insulating material, and a metal container 52 formed from a metal. Examples of the electrical insulating material described above are glass such as borosilicate glass and ceramics such as alumina. In this embodiment, the electrical insulating material is glass, and the electrical insulating container is a glass container 51.

The glass container 51 is formed cylindrical. The glass container 51 forms a gap between the anode hood 30 and itself. The glass container 51 can be prepared, for example, by airtightly bonding a plurality of glass members together by fusion. Since the glass container 51 is radiolucent, the X-ray emitted from the anode target 21 passes through the glass container 51 to be emitted to the outside of the vacuum envelope 50.

The metal container 52 is airtightly connected to the glass container 51 and the anode 20. The metal container 52 is airtightly fixed to at least one of the target body 21a and the anode extending portion 22. Here, the metal container 52 is airtightly connected to the anode extending portion 22 by brazing. Further, the metal container 52 and the glass container 51 are airtightly connected to each other by fusion. In this embodiment, the metal container 52 is formed annular. Further, the metal container 52 is formed, for example, using Kovar. The coefficient of thermal expansion of the metal container 52 is substantially equal to that of the glass container 51.

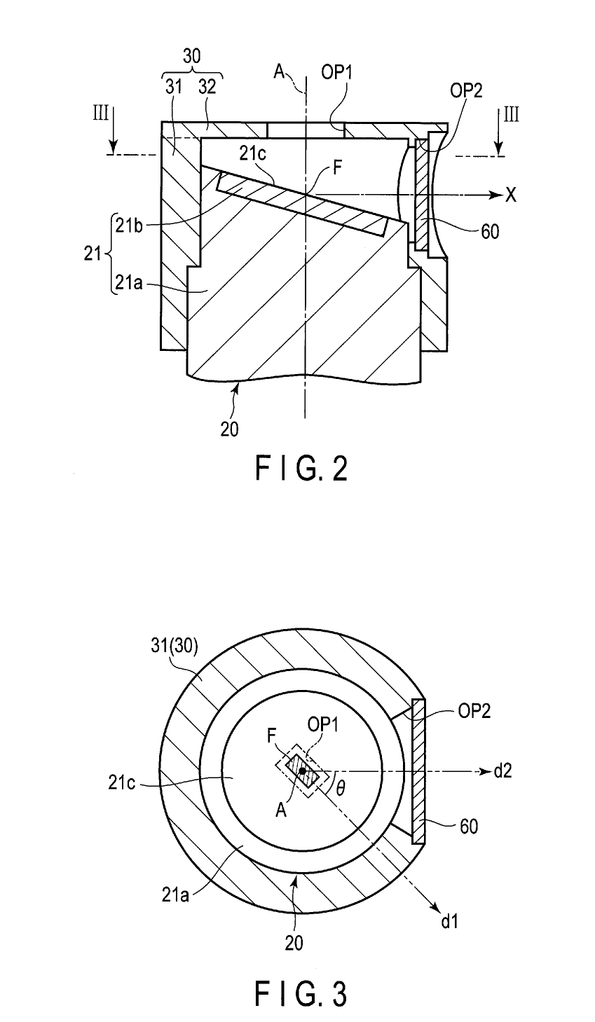

As shown in FIG. 2, the cylindrical portion 31 (anode hood 30) comprises a second opening OP2 which allows an X-ray emitted from the focal spot F formed on the target surface 21c, to pass therethrough. In this embodiment, the second opening OP2 opposes the target surface 21c along a direction perpendicular to the tube axis A. With the second opening OP2 provided, the absorptivity of the available X-ray by the anode hood 30 can be reduced to 0%.

The X-ray transmissive window 60 blocks the second opening OP2 of the anode hood 30, and transmits X-rays. The X-ray transmissive window 60 is also accommodated in the vacuum envelope 50. The X-ray transmissive window 60 is formed from a material containing at least one of beryllium, graphite, chlorofluorocarbon (CFC), beryllia, boron (B), boron nitride (BN) and boron carbide (B4C).

In this embodiment, the X-ray transmissive window 60 is formed from a material mainly containing one of beryllium, graphite, CFC, beryllia, B, BN and boron carbide.

As shown in FIG. 3, the focal point F has a long axis. When the anode 20 is viewed from the cathode 10 side along the tube axis A, the long axis of the focal point F extends along the first direction d1 described above. Here, a direction to the center of the X-ray transmissive window 60 from the focal point F when the anode 20 and the X-ray transmissive window 60 are viewed from the cathode 10 side along the tube axis A, is defined as a second direction d2. Further, an angle made with respect to the second direction d2 when the first direction d1 is pivoted clockwise or counter-clockwise is defined as θ. In this embodiment, the angle θ is an angle made with respect to the second direction d2 against the first direction d1 as it is pivoted clockwise. The angle θ is any angle but 0 degree.

Preferably, it should be: 0°<θ≤90°. For example, 1°≤θ≤90°. With this angle, it is possible to avoid such a problem that the anode 20 itself shields X-rays.

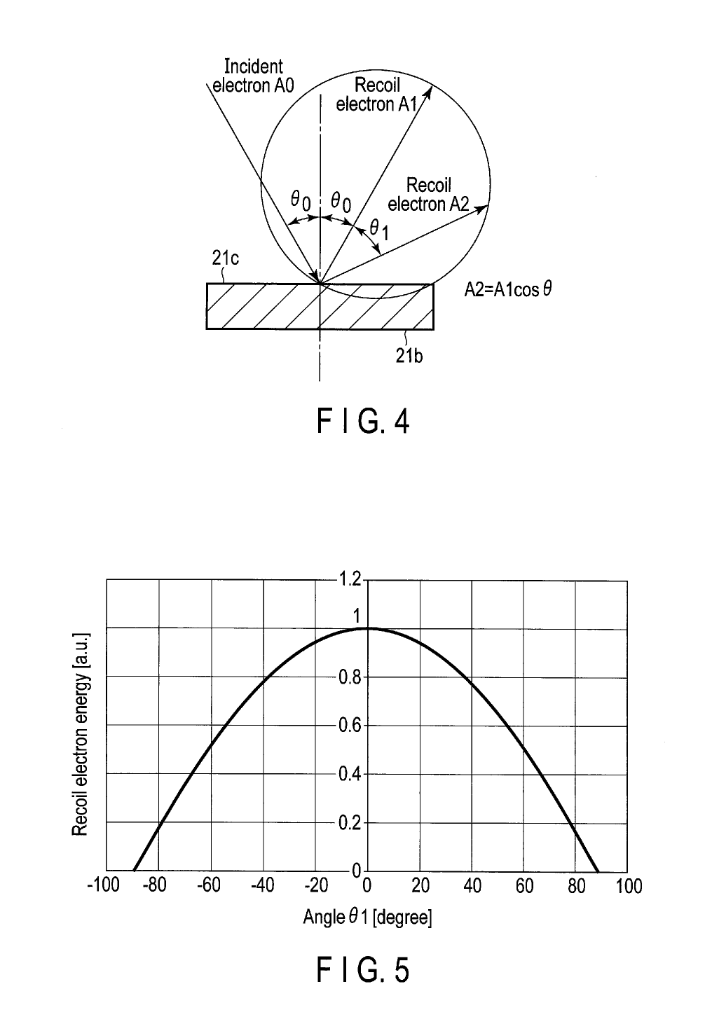

Here, the inventors made a research on the angle distribution (energy distribution) of recoil electron. FIG. 5 is a graph showing a change in recoil electron energy with respect to an angle θ₁ shown in FIG. 4.

As shown in FIGS. 4 and 5, as to the recoil electron of an electron beam made incident on the target surface 21c at an angle θ₀ with respect to a normal thereof, a component A1 of the angle θ₀ exhibits the maximum energy, and the energy reduces as the angle θ₁ changes.

Further, the inventors also researched the angle distribution in X-ray intensity.

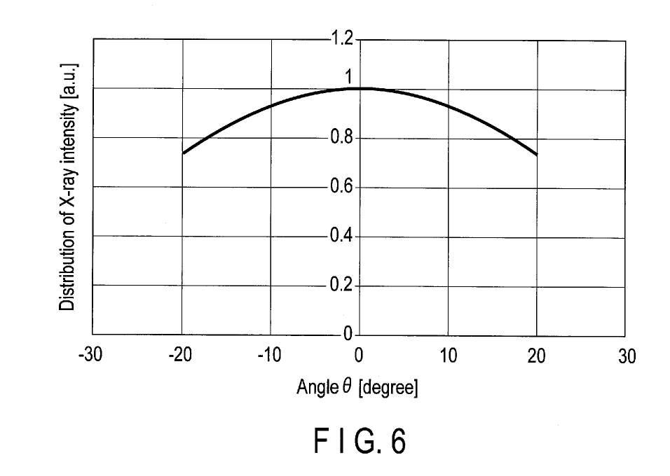

As shown in FIG. 6, if the angle θ shown in FIG. 3 is set to 15°, about 85% of X-ray intensity can be obtained in the second direction d2. Note that the X-ray intensity in the first direction d1 is 100% as a reference. Moreover, as can be seen from FIG. 5, when θ=15°, 50% or more of recoil electron energy can be absorbed by the anode hood 30.

According to the stationary anode X-ray tube 1 of the embodiment configured as described above, the X-ray tube 1 comprises a cathode 10, an anode 20, an anode hood 30, an X-ray transmissive window 60 and a vacuum envelope 50. The anode hood 30 can capture recoil electrons ejected out of the anode target 21. Therefore, the amount of the recoil electron returning to the target surface 21c, and the amount of the recoil electron rushing into the glass container 51 can be reduced.

The angle θ may be any degree but 0°. As compared to the case where: θ=0°, the amount of the recoil electron emitted in the second direction d2, which is also a main direction of the X-ray radiation can be suppressed, and thus the amount of the recoil electron which collides with the X-ray transmissive window 60 can be reduced. As a result, the rise of the temperature of the X-ray transmissive window 60 can be suppressed. In the case where the X-ray tube voltage is no higher than 125 kV, which is usually used for X-ray tubes mainly in diagnosis, the reduction of X-ray dosage in a desired direction of X-ray radiation is small even if the angle is set to 0°<θ≤90°. Here, the size of the effective focal spot varies with the angle θ, and therefore the angle θ should just be set so to be able to obtained a desired size of the focal spot F.

To summarize, according to the embodiment described above, the amount of the recoil electron emitted in the main direction of X-ray radiation by the X-ray tube 1 can be reduced to suppress the damage of the X-ray transmissive window 60, and thus the X-ray input conditions can be improved as compared to the case where: θ=0°. Therefore, it becomes possible to provide X-ray images with a higher S/N ratio in contrast and improved image information as compared to the case where: θ=0°. Moreover, the gas emission from the X-ray transmissive window 60 and the vapor deposition on the vacuum envelope 50 can be suppressed, thereby making it possible to provide be an X-ray tube which can output X-rays stably for a long period.

As set forth above, a stationary anode X-ray tube 1 which can relax the input limitation, can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the embodiment described above is applicable to various kinds of stationary anode X-ray tubes. For example, the embodiment described above is applicable not only to anode grounding X-ray tubes but also to cathode grounding type X-ray tubes and neutral ground type X-ray tubes. In the case of a cathode grounding type X-ray tube, a cathode 10 is grounded and a positive high voltage is applied to an anode target 21 (anode 20) and an anode hood 30. In the case of a neutral ground type X-ray tube, a negative high voltage is applied to the cathode 10, and a positive high voltage is applied to the anode target 21 (anode 20) and the anode hood 30.

What is claimed is:

1. A stationary anode X-ray tube comprising:
a cathode which emits electrons;
an anode disposed to oppose the cathode in a direction along a tube axis and comprising a target surface on which a focal spot which emits an X-ray is formed as emitted with an electron emitted from the cathode;
an anode hood fixed to the anode, extending to a side of the cathode, surrounding the target surface, set at a same potential as that of the anode, and comprising a first opening allowing electrons directed to the target surface from the cathode to pass therethrough and a second opening allowing an X-ray emitted from the focal spot to pass therethrough;
an X-ray transmissive window which blocks the second opening of the anode hood and transmits an X-ray; and
an electrical insulating vacuum envelope which accommodates the cathode, the anode, the anode hood and the X-ray transmissive window,
the target surface being an inclined surface disposed to be spaced further away from the cathode towards a first direction normal to the tube axis, and
if, with respect to a second direction directed from the focal spot to a center of the X-ray transmissive window when the anode and the X-ray transmissive window are viewed from the side of the cathode along the tube axis, an angle made with respect to the second direction when the first direction is pivoted clockwise or counter-clockwise is an angle θ, the angle θ being any angle but 0°.

2. The X-ray tube of claim 1, wherein
0°≤θ≤90°.

3. The X-ray tube of claim 1, wherein
the X-ray transmissive window is formed from a material containing at least one of beryllium, graphite, chlorofluorocarbon, beryllia, boron, boron nitride and boron carbide.

4. The X-ray tube of claim 1, wherein
when the anode is viewed from the side of the cathode along the tube axis, the focal point has a long axis elongating along the first direction.
